(19) United States
(12) Patent Application Publication
(10) Pub. No.: US 2024/0017106 A1
(43) Pub. Date: Jan. 18, 2024

(54) FIRE-SPREADING PREVENTION AND FLAME-RETARDANT MATERIAL

(71) Applicant: Cheng Uei Precision Industry Co., LTD., New Taipei City (TW)

(72) Inventors: JEN-KAI HUANG, New Taipei City (TW); PING-YU LEE, New Taipei City (TW); HSU-LUN HSU, New Taipei City (TW); SSU-YING CHEN, New Taipei City (TW)

(21) Appl. No.: 18/114,209

(22) Filed: Feb. 24, 2023

(30) Foreign Application Priority Data
Jul. 15, 2022 (CN) 202210828841.6

(51) Int. Cl. A62C 35/10; A62C 3/16; C09K 21/02; C09J 11/04; C09J 7/38; C09J 7/24; H01M 50/383

(52) U.S. Cl. CPC A62C 35/10; A62C 3/16; C09K 21/02; C09J 11/04; C09J 7/38; C09J 7/243; H01M 50/383; C09J 2405/00; C09J 2423/046; C09J 2301/408; C09J 2203/33

(57) ABSTRACT

A fire-spreading prevention and flame-retardant material includes a gel carrier, a first flame retardant, a second flame retardant, a first flame barrier, a second flame barrier and an adhesive. The first flame retardant uses a collosol way to be distributed in the gel carrier. The second flame retardant uses the collosol way to be distributed in the gel carrier. The first flame barrier uses the collosol way to be distributed in the gel carrier. The second flame barrier uses the collosol way to be distributed in the gel carrier. The adhesive is dissolved in the gel carrier to improve a property of the gel carrier.

### CROSS-REFERENCE TO RELATED APPLICATION

The present application is based on, and claims priority from, China Patent Application No. 202210828841.6, filed Jul. 15, 2022, the disclosure of which is hereby incorporated by reference herein in its entirety.

### BACKGROUND OF THE INVENTION

### 1. Field of the Invention

The present invention generally relates to a fire-spreading prevention and flame-retardant material, and more particularly to a fire-spreading prevention and flame-retardant material with good fire-spreading prevention and explosion-proof effects, and the fire-spreading prevention and flame-retardant material having a heat dissipation effect and an even heat distribution effect.

### 2. The Related Art

Usually, lithium battery cells are used in a high-energy lithium battery cell module system, the lithium battery cells are unstable to burn or explode under affections of external force factors which include heat, impacts, collisions, etc. Because the lithium battery cells are stacked tightly, when one lithium battery cell has a thermal runaway, a condition that the whole lithium battery cell module is burnt out is caused to generate heat, and the heat triggers an uncontrollable chain reaction, and an explosion is even caused to result in a happening of a serious disaster.

In conclusion, it is necessary to provide a fire-spreading prevention and flame-retardant material which avoids battery cells of a battery cell module from a thermal runaway, so that a safety of the battery cell module is maintained.

### SUMMARY OF THE INVENTION

An object of the present invention is to provide a fire-spreading prevention and flame-retardant material with good fire-spreading prevention and explosion-proof effects, and the fire-spreading prevention and flame-retardant material has a heat dissipation effect and an even heat distribution effect. The fire-spreading prevention and flame-retardant material includes a gel carrier, a first flame retardant, a second flame retardant, a first flame barrier, a second flame barrier and an adhesive. A weight percentage of the gel carrier in the fire-spreading prevention and flame-retardant material is ranged from 40% to 50%. The gel carrier includes sugar and agar. The first flame retardant uses a collosol way to be distributed in the gel carrier. A weight percentage of the first flame retardant in the fire-spreading prevention and flame-retardant material is ranged from 20% to 30%. The first flame retardant includes aluminum hydroxide. The second flame retardant uses the collosol way to be distributed in the gel carrier. A weight percentage of the second flame retardant in the fire-spreading prevention and flame-retardant material is ranged from 20% to 30%. The second flame retardant includes magnesium hydroxide. The first flame barrier uses the collosol way to be distributed in the gel carrier. A weight percentage of the first flame barrier in the fire-spreading prevention and flame-retardant material is ranged from 1% to 5%. The first flame barrier includes glass sands. The second flame barrier uses the collosol way to be distributed in the gel carrier. A weight percentage of the second flame barrier in the fire-spreading prevention and flame-retardant material is ranged from 0.1% to 0.5%. The second flame barrier includes expanded graphite. The adhesive is dissolved in the gel carrier to improve a property of the gel carrier. A weight percentage of the adhesive in the fire-spreading prevention and flame-retardant material is ranged from 0.1% to 0.5%. The adhesive includes zinc borate.

Another object of the present invention is to provide a fire-spreading prevention and flame-retardant material used to wrap a battery cell. The fire-spreading prevention and flame-retardant material includes a gel carrier, a first flame retardant, a second flame retardant, a first flame barrier, a second flame barrier and an adhesive. A weight percentage of the gel carrier in the fire-spreading prevention and flame-retardant material is ranged from 40% to 50%. The gel carrier includes water, agar and sugar. The first flame retardant is distributed in the gel carrier. A weight percentage of the first flame retardant in the fire-spreading prevention and flame-retardant material is ranged from 20% to 30%. The first flame retardant includes aluminum hydroxide. The second flame retardant is distributed in the gel carrier. A weight percentage of the second flame retardant in the fire-spreading prevention and flame-retardant material is ranged from 20% to 30%. The second flame retardant includes magnesium hydroxide. The first flame barrier uses a collosol way to be distributed in the gel carrier. A weight percentage of the first flame barrier in the fire-spreading prevention and flame-retardant material is ranged from 1% to 5%. The first flame barrier includes glass sands. The second flame barrier uses the collosol way to be distributed in the gel carrier. A weight percentage of the second flame barrier in the fire-spreading prevention and flame-retardant material is ranged from 0.1% to 0.5%. The second flame barrier includes expanded graphite. The adhesive is dissolved in the gel carrier to improve a property of the gel carrier. A weight percentage of the adhesive in the fire-spreading prevention and flame-retardant material is ranged from 0.1% to 0.5%.

As described above, the gel carrier of the fire-spreading prevention and flame-retardant material in accordance with the present invention carries the first flame retardant, the second flame retardant, the first flame barrier, the second flame barrier and the adhesive, so the fire-spreading prevention and flame-retardant material has a good fire-spreading prevention effect and a good explosion-proof effect, and simultaneously, the battery cell has a heat dissipation effect and an even heat distribution effect.

### BRIEF DESCRIPTION OF THE DRAWINGS

The present invention will be apparent to those skilled in the art by reading the following description, with reference to the attached drawings, in which:

FIG. 1 is a schematic diagram that shows a material composition of a fire-spreading prevention and flame-retardant material in accordance with a preferred embodiment of the present invention; and

FIG. 2 is a perspective view that shows the fire-spreading prevention and flame-retardant material is assembled to a battery cell according to the preferred embodiment of the present invention.

### DETAILED DESCRIPTION OF THE PREFERRED EMBODIMENT

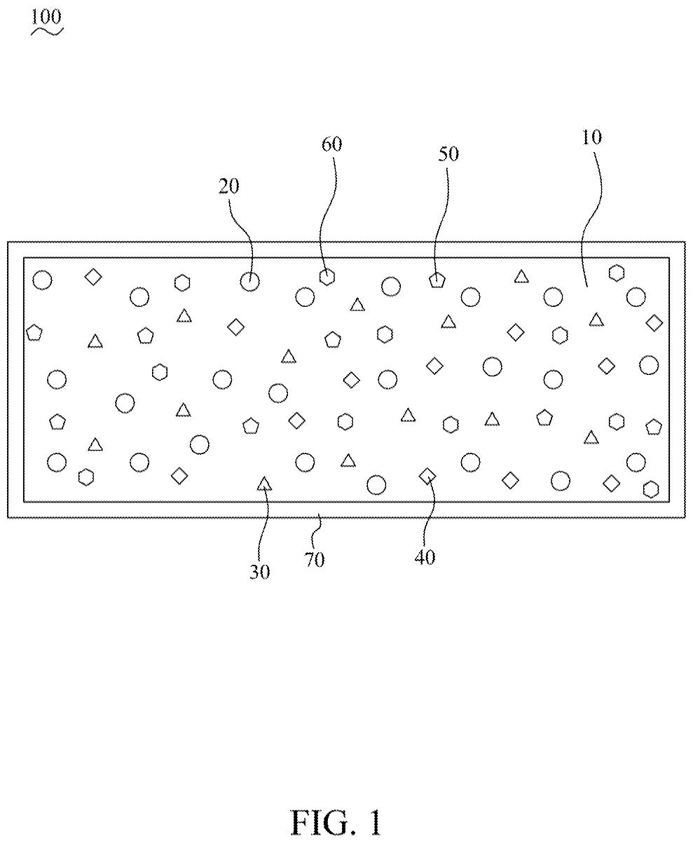

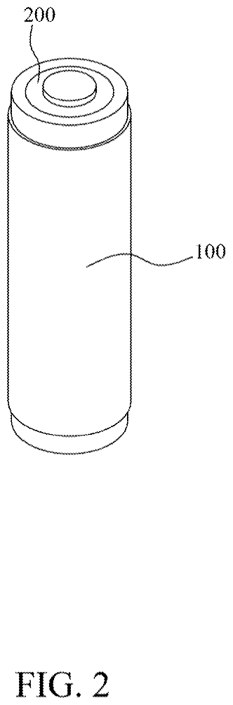

Referring to FIG. 1 and FIG. 2, a fire-spreading prevention and flame-retardant material 100 in accordance with a preferred embodiment of the present invention is shown. The fire-spreading prevention and flame-retardant material 100 is applied to a battery cell 200. The fire-spreading prevention and flame-retardant material 100 is used to wrap the battery cell 200, when the battery cell 200 is damaged to cause a fire, the fire-spreading prevention and flame-retardant material 100 prevents the fire from spreading to adjacent elements. The adjacent elements are at least two of the battery cells 200, printed circuit boards, cables and battery holders. The fire-spreading prevention and flame-retardant material 100 is without being limited to be applied to the battery cell 200, the fire-spreading prevention and flame-retardant material 100 is also able to be used in a building or a fabric, etc.

The fire-spreading prevention and flame-retardant material 100 includes a gel carrier 10 which is composed of a solvent and a gelling agent. A weight percentage of the gel carrier 10 in the fire-spreading prevention and flame-retardant material 100 is ranged from 40% to 50%. The gel carrier 10 includes sugar and agar. In the preferred embodiment, the gel carrier 10 further includes water and the gelling agent. The gel carrier 10 uses the water as the solvent, and the gel carrier 10 uses the agar as the gelling agent. Because a main component of the gel carrier 10 is water, when the gel carrier 10 suffers a high temperature of a flame, the water of the gel carrier 10 has a cooling effect. The fire-spreading prevention and flame-retardant material 100 further includes a polyethylene film 70 covered on an outer surface of the gel carrier 10 to block the gel carrier 10 from contacting with an external environment. When the sugar contained in the gel carrier 10 suffers the high temperature of the flame, carbon chars are formed to obstruct the flame, and the polyethylene film 70 blocks the gel carrier 10 from contacting with the external environment to avoid breeding mycetes or ants.

The gel carrier 10 further includes a first flame retardant 20. The first flame retardant 20 is solid. The first flame retardant 20 uses a collosol way to be distributed in the gel carrier 10. A weight percentage of the first flame retardant 20 in the fire-spreading prevention and flame-retardant material 100 is ranged from 20% to 30%. The first flame retardant 20 includes aluminum hydroxide. In this preferred embodiment, the first flame retardant 20 is the aluminum hydroxide (Al(OH)₃·nH₂O). When the aluminum hydroxide suspended in the gel carrier 10 suffers the flame, and the aluminum hydroxide suspended in the gel carrier 10 heats up to 130° C., the aluminum hydroxide will decompose into aluminum oxide (Al₂O₃) and the water (H₂O). Because the released water generates a phase change at a high temperature to transform into water vapor. A volume of the water vapor increases rapidly, many cavities are generated in the gel carrier 10 to further obstruct heat and the flame.

The gel carrier 10 further includes a second flame retardant 30. The second flame retardant 30 is solid. The second flame retardant 30 uses the collosol way to be distributed in the gel carrier 10. A weight percentage of the second flame retardant 30 in the fire-spreading prevention and flame-retardant material 100 is ranged from 20% to 30%. The second flame retardant 30 includes magnesium hydroxide. In this preferred embodiment, the second flame retardant 30 is the magnesium hydroxide (Mg(OH)₂·nH₂O). When the magnesium hydroxide suspended in the gel carrier 10 suffers the flame, and the magnesium hydroxide suspended in the gel carrier 10 heats up to 150° C., the magnesium hydroxide will decompose into magnesium oxide (MgO) and the water (H₂O). Because the released water generates the phase change at the high temperature to transform into the water vapor. The volume of the water vapor increases rapidly, many cavities are generated in the gel carrier 10 to further obstruct the heat and the flame.

The gel carrier 10 further includes a first flame barrier 40. The first flame barrier 40 uses the collosol way to be distributed in the gel carrier 10. A weight percentage of the first flame barrier 40 in the fire-spreading prevention and flame-retardant material 100 is ranged from 1% to 5%. The first flame barrier 40 includes glass sands. In this preferred embodiment, the first flame barrier 40 is the glass sands. When the glass sands suspended in the gel carrier 10 suffer the high temperature of the flame, the glass sands are molten to form a non-combustible barrier layer.

The gel carrier 10 further includes a second flame barrier 50. The second flame barrier 50 uses the collosol way to be distributed in the gel carrier 10. A weight percentage of the second flame barrier 50 in the fire-spreading prevention and flame-retardant material 100 is ranged from 0.1% to 0.5%. The second flame barrier 50 includes expanded graphite. In this preferred embodiment, the second flame barrier 50 is the expanded graphite. When the expanded graphite suspended in the gel carrier 10 suffers the high temperature of the flame, a volume of the expanded graphite increases rapidly, the gel carrier 10 forms a porous structure for further obstructing the flame and the heat.

The gel carrier 10 further includes an adhesive 60. The adhesive 60 is dissolved in the gel carrier 10 to improve a property of the gel carrier 10. A weight percentage of the adhesive 60 in the fire-spreading prevention and flame-retardant material 100 is ranged from 0.1% to 0.5%. The adhesive 60 includes zinc borate. In this preferred embodiment, the adhesive 60 is the zinc borate. The adhesive 60 is used to glue materials in the gel carrier 10, and the zinc borate is also a fire retardant.

Referring to FIG. 1 and FIG. 2, when the battery cell 200 suffers the high temperature or the battery cell 200 is impacted by an external force, the battery cell 200 is apt to be unstable to explode, so an outer surface of the battery cell 200 is covered with the fire-spreading prevention and flame-retardant material 100 to improve an fire-spreading prevention effect and an explosion-proof effect of the battery cell 200, and simultaneously, the battery cell 200 has a heat dissipation effect and an even heat distribution effect. In the preferred embodiment, a material combination used in this preferred embodiment has a thermal conductivity of 1.02 W/m° C.

As described above, the gel carrier 10 of the fire-spreading prevention and flame-retardant material 100 in accordance with the present invention carries the first flame retardant 20, the second flame retardant 30, the first flame barrier 40, the second flame barrier 50 and the adhesive 60, so the fire-spreading prevention and flame-retardant material 100 has the good fire-spreading prevention effect and the good explosion-proof effect, and simultaneously, the battery cell 200 has the heat dissipation effect and the even heat distribution effect.

Although the invention is disclosed above by the foregoing embodiment, however, the embodiment is unused to limit the present invention. Any person who is skilled in a similar art may make some changes and embellishments without departing from a spirit and a scope of the present invention, therefore a patent protection scope of the present invention shall be defined as a criterion according to an application patent scope attached to this specification.

What is claimed is:

1. A fire-spreading prevention and flame-retardant material, comprising:
a gel carrier, a weight percentage of the gel carrier in the fire-spreading prevention and flame-retardant material being ranged from 40% to 50%, the gel carrier including sugar and agar;
a first flame retardant using a collosol way to be distributed in the gel carrier, a weight percentage of the first flame retardant in the fire-spreading prevention and flame-retardant material being ranged from 20% to 30%, the first flame retardant including aluminum hydroxide;
a second flame retardant using the collosol way to be distributed in the gel carrier, a weight percentage of the second flame retardant in the fire-spreading prevention and flame-retardant material being ranged from 20% to 30%, the second flame retardant including magnesium hydroxide;
a first flame barrier using the collosol way to be distributed in the gel carrier, a weight percentage of the first flame barrier in the fire-spreading prevention and flame-retardant material being ranged from 1% to 5%, the first flame barrier including glass sands;
a second flame barrier using the collosol way to be distributed in the gel carrier, a weight percentage of the second flame barrier in the fire-spreading prevention and flame-retardant material being ranged from 0.1% to 0.5%, the second flame barrier including expanded graphite; and
an adhesive dissolved in the gel carrier to improve a property of the gel carrier, a weight percentage of the adhesive in the fire-spreading prevention and flame-retardant material being ranged from 0.1% to 0.5%, the adhesive including zinc borate.

2. The fire-spreading prevention and flame-retardant material as claimed in claim 1, further comprising a polyethylene film covered on an outer surface of the gel carrier to block the gel carrier from contacting with an external environment.

3. The fire-spreading prevention and flame-retardant material as claimed in claim 1, wherein the gel carrier further includes water and a gelling agent.

4. The fire-spreading prevention and flame-retardant material as claimed in claim 3, wherein the gel carrier uses the agar as the gelling agent.

5. The fire-spreading prevention and flame-retardant material as claimed in claim 1, wherein the first flame retardant is the aluminum hydroxide.

6. The fire-spreading prevention and flame-retardant material as claimed in claim 1, wherein the second flame retardant is the magnesium hydroxide.

7. The fire-spreading prevention and flame-retardant material as claimed in claim 1, wherein the first flame barrier is the glass sands.

8. The fire-spreading prevention and flame-retardant material as claimed in claim 1, wherein the second flame barrier is the expanded graphite.

9. The fire-spreading prevention and flame-retardant material as claimed in claim 1, wherein the adhesive is the zinc borate.

10. A fire-spreading prevention and flame-retardant material used to wrap a battery cell, comprising:
a gel carrier, a weight percentage of the gel carrier in the fire-spreading prevention and flame-retardant material being ranged from 40% to 50%, the gel carrier including water, agar and sugar;
a first flame retardant distributed in the gel carrier, a weight percentage of the first flame retardant in the fire-spreading prevention and flame-retardant material being ranged from 20% to 30%, the first flame retardant including aluminum hydroxide;
a second flame retardant distributed in the gel carrier, a weight percentage of the second flame retardant in the fire-spreading prevention and flame-retardant material being ranged from 20% to 30%, the second flame retardant including magnesium hydroxide;
a first flame barrier using a collosol way to be distributed in the gel carrier, a weight percentage of the first flame barrier in the fire-spreading prevention and flame-retardant material being ranged from 1% to 5%, the first flame barrier including glass sands;
a second flame barrier using the collosol way to be distributed in the gel carrier, a weight percentage of the second flame barrier in the fire-spreading prevention and flame-retardant material being ranged from 0.1% to 0.5%, the second flame barrier including expanded graphite; and
an adhesive dissolved in the gel carrier to improve a property of the gel carrier, a weight percentage of the adhesive in the fire-spreading prevention and flame-retardant material being ranged from 0.1% to 0.5%.

11. The fire-spreading prevention and flame-retardant material as claimed in claim 10, further comprising a polyethylene film covered on an outer surface of the gel carrier to block the gel carrier from contacting with an external environment.

12. The fire-spreading prevention and flame-retardant material as claimed in claim 10, wherein the adhesive includes zinc borate.
